(19) United States
(12) Patent Application Publication
(10) Pub. No.: US 2013/0159952 A1
(43) Pub. Date: Jun. 20, 2013

(54) COMBINING MULTIPLE TIMING MODES OF INTEGRATED CIRCUIT

(71) Applicant: International Business Machines Corporation, Armonk, NY (US)

(72) Inventors: Jia Niu, Shanghai (CN); Hong Wei Dai, Shanghai (CN); Tie Peng Cheng, Beijing (CN); Gong Qiong Li, Shanghai (CN); Xia Li, Shanghai (CN); Fan Zhou, Shanghai (CN)

(73) Assignee: INTERNATIONAL BUSINESS MACHINES CORPORATION, Armonk, NY (US)

(21) Appl. No.: 13/716,501

(22) Filed: Dec. 17, 2012

(30) Foreign Application Priority Data
Dec. 20, 2011 (CN) 201110456741.7

(51) Int. Cl. G06F 17/50

(52) U.S. Cl. CPC G06F 17/5068
USPC 716/113

(57) ABSTRACT

A method and system for combining multiple timing modes of an integrated circuit. The method includes the steps of: creating logic groups for at least one logic device in the circuit according to at least one clock driving the at least one logic device, performing static timing analysis to the circuit in multiple given timing modes, obtaining at least one relationship between the logic groups in each of the multiple given timing modes according to a result of the static timing analysis, and combining the obtained at least one relationship between the logic groups in each of the multiple given timing modes

This application claims priority under 35 U.S.C. §119 from Chinese Patent Application No. 201110456741.7 filed Dec. 20, 2011, the entire contents of which are incorporated herein by reference.

### BACKGROUND OF THE INVENTION

1. Field of the Invention

The present invention generally relates to integrated circuit design. More particularly the present invention generally relates to a method and system for combining multiple timing modes of an integrated circuit.

2. Related Art

One of important steps of the flow of integrated circuit design is timing analysis, wherein first for the prediction of the clock effect, static timing analysis is performed using an ideal clock model, and then a clock tree is inserted. Clock tree insertion is also termed clock tree planning The existing clock tree planning process can be implemented manually or by electronic design automation (EDA) tools. The most prevalent method is that clock trees are accomplished using automation tools whose basic principle is to place a buffer at a proper location to minimize the clock skew from a clock root to each timing device, according to the distance from each timing device to the clock root. The inserted tree-like signal relay network formed by buffers is termed a clock tree. The inserted clock tree is required to satisfy timing constraints in a timing constraint file so as to maintain timing closure and achieve designed effects. Finally, clock tree adjustment and timing analysis with clock is performed. However, the time spent in clock tree planning, clock tree insertion and clock tree adjustment is often calculated by days or even weeks, which is a key factor that affects the design period in the integrated circuit design process.

Particularly, in current integrated circuit design, one chip often has multiple timing modes. In other words, a logic circuit of the chip can operate at a plurality of different clock frequencies. In this case, a solution in traditional designs is to perform both static and dynamic timing analysis for each timing mode such that all of multiple timing modes achieve timing closure. However, the timing analysis of only one timing mode already consumes a considerable time; the timing analysis of multiple timing modes obviously needs a much larger amount of time and greatly extends the whole design period. In a method of a user combining multiple timing modes to fewer timing modes, only one to the best, a solution is to use timing requirements of the maximum clock frequency. However, this solution is prone to problems in a case that logic domains of a circuit interact with one another.

Another solution in the prior art is to first receive a plurality of required timing constraint files in a plurality of different timing, generate a combined timing constraint file that completely consolidates multiple timing constraints to a super mode in which all clock waveforms of all timing constraint files are saved, and finally perform times of physical design iterations using physical design tools. However, such a combining approach takes only timing constraints into consideration without the circuit. In addition, timing redundancy is also not considered in the combining process. This combining approach fails to solve problems for some integrated circuit design, which will be explained in detail below.

### SUMMARY OF THE INVENTION

One aspect of the invention includes a method of combining multiple timing modes of an integrated circuit. The method includes the steps of: creating logic groups for at least one logic device in the circuit according to at least one clock driving the at least one logic device, performing static timing analysis to the circuit in multiple given timing modes, obtaining at least one relationship between the logic groups in each of the multiple given timing modes according to a result of the static timing analysis, and combining the obtained at least one relationship between the logic groups in each of the multiple given timing modes.

Another aspect of the invention includes a system for combining multiple timing modes of an integrated circuit. The system includes: grouping means configured to create logic groups for at least one logic device in the circuit according to at least one clock driving the at least one logic device, static timing analysis means configured to perform static timing analysis to the circuit in multiple given timing modes, relationship obtaining means configured to obtain at least one relationship between the logic groups in each of the multiple given timing modes according to a result of the static timing analysis, and combining means configured to combine the obtained at least one relationship between the logic groups in each of the multiple given timing modes.

### BRIEF DESCRIPTION OF THE DRAWINGS

The foregoing and other objects, features and advantages of the present invention will become more apparent from the more detailed description of exemplary embodiments, when taken in conjunction with the figures wherein the same reference numerals typically represent like components throughout the exemplary embodiments of the present invention.

FIG. 1 illustrates an example of actual integrated circuit design.

FIG. 2 illustrates a different timing mode of another actual integrated circuit design.

FIG. 3 schematically illustrates a flowchart of a method of combining multiple timing modes of an integrated circuit according to one embodiment of the present invention.

FIG. 4 is a schematic view of a conventional circuit that can be employed to implement a feature of an embodiment of the present invention.

FIG. 5 illustrates a structural block diagram of a system 500 for combining multiple modes of an integrated circuit according to an embodiment of the present invention.

### DETAILED DESCRIPTION OF THE PREFERRED EMBODIMENTS

Therefore, there is a need for a method and system for combining multiple timing modes of an integrated circuit, such that designers can fast combine various kinds of clock modes, reduce the design time and increase the design efficiency.

According to an aspect of the present invention, there is provided a method of combining multiple timing modes of an integrated circuit, the method including: creating a logic group for a logic device in the circuit according to a clock driving the logic device, performing static timing analysis to the circuit in multiple given timing modes, obtaining relationships between the logic groups in each of the multiple given timing modes according to a result of the static timing analysis, and combining the obtained relationships between the logic groups in each of the multiple given timing modes.

According to another aspect of the present invention, there is provided a system for combining multiple timing modes of an integrated circuit, the system including: grouping means configured to create a logic group for a logic device in the circuit according to a clock driving the logic device, static timing analysis means configured to perform static timing analysis to the circuit in multiple given timing modes, relationship obtaining means configured to obtain relationships between the logic groups in each of the multiple given timing modes according to a result of the static timing analysis, and combining means configured to combine the obtained relationships between the logic groups in each of the multiple given timing modes.

Preferable embodiments of the present invention will be described in more detail with reference to the figures that illustrate preferable embodiments of the present invention. However, the present invention can be implemented in various forms and should not be construed as being limited by the embodiments illustrated here. On the contrary, these embodiments are provided to make the present invention more thorough and complete and to fully convey the scope of the present invention to those skilled in the art.

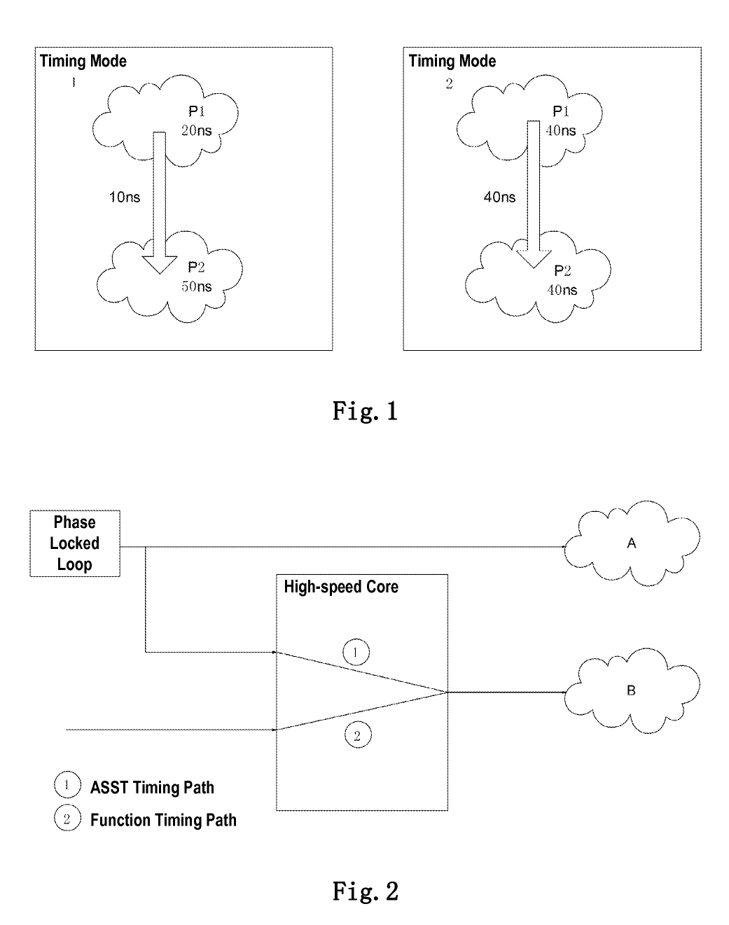

FIG. 1 illustrates an example of actual integrated circuit design. As illustrated in Table 1, the circuit includes two logic domains P1, P2 and two timing modes. Each logic domain has different timing requirements in different timing modes, wherein for example, data 20 ns indicates that a clock period of the first logic domain P1 in the first timing mode is 20 nanoseconds (ns). A DTA (Delay and Timing Adjustment) parameter is mainly used for calculating timing adjustment during timing check. For example, in a calculation with the root being a register clock output, the signal end being a register clock receive, the signal root arrival time being AT1 and the signal end arrival time being AT2, the timing analysis will check the signal setup time, which can be represented by the formula:

AT2<(AT1+DTA parameter−signal setup time)

In Table 1, in the first timing mode the DTA parameter from the logic domain P2 to the logic domain P1 is 10 ns.

TABLE 1
Different Timing Requirements of Actual Integrated Circuit Design

| | Timing requirement | Timing requirement | |
|---|---|---|---|
| | of first logic | of first logic | DTA |
| | domain P1 | domain P2 | (P2−>P1) |
| First timing | 20 ns | 50 ns | 10 ns |
| mode | | | |
| Second timing | 40 ns | 40 ns | 40 ns |
| mode | | | |

FIG. 2 illustrates a different timing mode of another actual integrated circuit design. The circuit mainly functions to receive data at a high speed. During function timing analysis, a high-speed core provides a clock for logic domain B, an on-chip phase locked loop provides a clock for logic domain A, and the logic domain A and the logic domain B have interactions but no timing check exists therebetween because of different clock roots. However, the circuit being designed is often subjected to ASST (AT Speed Structural Test). The ASST timing is mainly for checking whether the chip's path that will be tested at a high speed by a tester has achieved timing closure. During ASST timing analysis, clocks of both the logic domain A and the logic domain B are provided by the same phase locked loop, and in turn, timing check happens to the interactions between the logic domain A and the logic domain B. In FIG. 2 the first path (i.e., the path indicated by circle 1) is an ASST mode path, and the second path (i.e., the path indicated by circle 2) is a function mode path. Normally, these two mode paths should have the same timing requirement. However, in this example since these two mode paths follow different paths, they have different timing requirements.

In multiple timing modes, logic devices of an integrated circuit operate at different clock frequencies. A straightforward idea of designers is that if the design satisfies a timing requirement at a maximum clock frequency, then it can satisfy all other timing requirements. In fact, this idea is however not completely correct. Regarding the example in Table 1, if timing requirements of the logic domains are combined simply using the maximum frequency (e.g., the minimum clock period), then the combined DTA will select the greatest common divisor of timing requirements of the different logic domains. A result of the combination using integrated circuit design tools is as illustrated in Table 2. Obviously, the combined DTA does not satisfy the requirement of the first timing mode. Hence, such simple combination cannot satisfy requirements of a design when logic domains have interactions between them.

Hereinafter, a simple introduction is presented to the redundancy of timing check. For example, regarding the example in Table 1, setup time checks when DTA=20 ns and DTA=40 ns will be conducted inside the logic domain P1, setup time checks when DTA=50 ns and DTA=40 ns will be conducted inside the logic domain P2, and setup time checks when DTA=10 ns and DTA=40 ns will be conducted from the logic domain 2 to the logic domain 1. Among them, the check inside the logic domain P1 when DTA=40 ns is redundant, because a check of 10 ns less than 40 ns is already conducted. Such a redundancy check will not change a result but prolong the design period. Likewise, regarding FIG. 2, such a redundancy check will also prolong the design period.

TABLE 2
Result of Combination Using Integrated Circuit
Design Tools for Circuit in FIG. 1

| | Timing requirement | Timing requirement | |
|---|---|---|---|
| | of first logic | of second logic | DTA |
| | domain P1 | domain P2 | (P2−>P1) |
| Maximum | 20 ns | 40 ns | 20 ns |
| frequency | | | |
| combination | | | |

In addition, regarding the example in FIG. 2, there is another solution in the prior art; that is, multiple timing constraint files required in different timing are received, and a combined timing constraint file is generated. However, such an approach merely combines all timing constraint files but does not know timing paths inside the circuit, i.e., not check the circuit. Hence, this approach does not know what internal timing paths of the high-speed core are like, or whether path 1 or path 2 exists. Even if this approach combines all timing constraint files, it cannot ensure that the ASST timing mode is included in a timing mode under the final combined timing constraint file.

Through analysis, inventors of the present invention find that the combination of different timing modes requires not only integrity, i.e., the combined timing mode covers all timing mode requirements, but also uniqueness, i.e., the combined timing mode has no timing redundancy. In other words, all timing modes are combined into one worst timing mode; as long as the worst timing mode can achieve timing closure during timing analysis, all timing modes can achieve timing closure. The worst timing mode might be one of required timing modes or differ from all required timing modes.

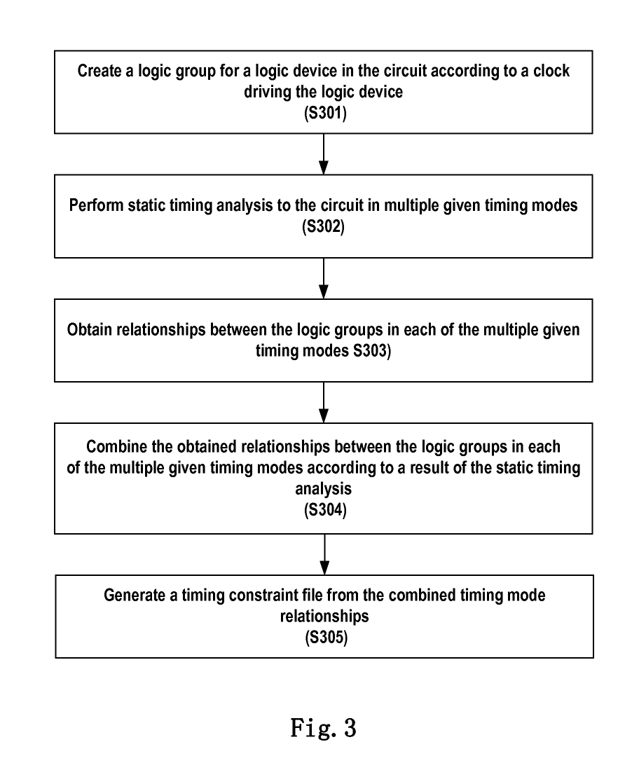

FIG. 3 schematically illustrates a flowchart of a method of combining multiple timing modes of an integrated circuit according to one embodiment of the present invention. According to FIG. 3, in step S301 a logic group is created for a logic device in the circuit according to a clock driving the logic device. In this step, grouping can be implemented by using integrated circuit design tools to backward trace a clock driving a logic device in the circuit, or by tracing a logic device driven by a clock from the clock. Preferably, logic devices driven by the same clock are grouped into the same logic group in the grouping process.

In step S302, static timing analysis is performed to the circuit in multiple given timing modes. The static timing analysis can be performed using existing integrated circuit timing analysis tools, such as PrimeTime from Synopsys or IBM EinsTimer. The static timing analysis has inputs of a circuit diagram without any timing information and timing constraint files in multiple given timing modes. And its outputs include a circuit with timing information such as a time of arrival and a clock phase on each node of the circuit, the DTA parameter between every two clocks, whether each register has setup time check violation, etc. Preferably, it is possible to make only one static timing analysis and then to proceed with subsequent steps by using a result of the static timing analysis. Of course, those skilled in the art can appreciate that multiple static timing analyses can be performed and then a better result is selected, which however consumes a longer time.

In step S303, relationships between the logic groups in each of the multiple given timing modes are obtained according to a result of the static timing analysis. The relationships between the logic groups include whether there exists an interaction between the logic groups, an interaction direction, an interaction parameter, and a parameter of internal interactions of the logic group.

In one embodiment of obtaining interactions and interaction directions between the logic groups in each of the multiple given timing modes, the clock is propagated in the circuit during the static timing analysis so as to determine whether there exists the interaction between the logic groups, and to obtain the interaction direction. Since during the static timing analysis the clock is propagated in the circuit, for example, the clock name of the clock root of the logic group A is clkA and the clock name of the clock root of the logic group B is clkB, if clkA appears in the logic group B after the completion of propagation, it indicates that the logic group A will transmit a signal to the logic group B, i.e., the logic group A interacts with the logic group B. When using this method of obtaining the relationships between the logic groups, it is only necessary to ensure that clocks at respective clock roots use different names.

In another embodiment of obtaining interactions and interaction directions between the logic groups in each of the multiple given timing modes, each logic device in a logic group is forward or backward traced to determine whether this logic group has interactions with other logic groups, and to obtain the interaction direction. For example, each logic device in the logic group A can be forward or backward traced; if the forward trace arrives at a logic device in the logic group B, it indicates that the logic group B will transmit a signal to the logic group A; if the backward trace arrives at a logic device in the logic group B, it indicates that the logic group A will transmit a signal to the logic group B. In this way, interactions between the logic groups are obtained.

In a further embodiment of obtaining interactions and interaction directions between the logic groups in each of the multiple given timing modes, connection relationships between all logic devices in the circuit are traversed to determine whether this logic group has interactions with other logic groups, and to obtain interaction directions. For example, the circuit structure can be saved as a data structure in a computer, which includes connection relationships between all logic devices in the circuit with each connection relationship including a starting node and an ending node. After all connection relationships are traversed, if it is found that the starting node and the ending node of a connection relationship are in different logic groups, it indicates that the logic group A and the logic group B interact.

In addition, there are many other embodiments, well known to those skilled in the art, of obtaining interactions and interaction directions between the logic groups in each of the multiple given timing modes. They are not enumerated here. Parameters of internal interactions of the logic group are typically defined by users themselves.

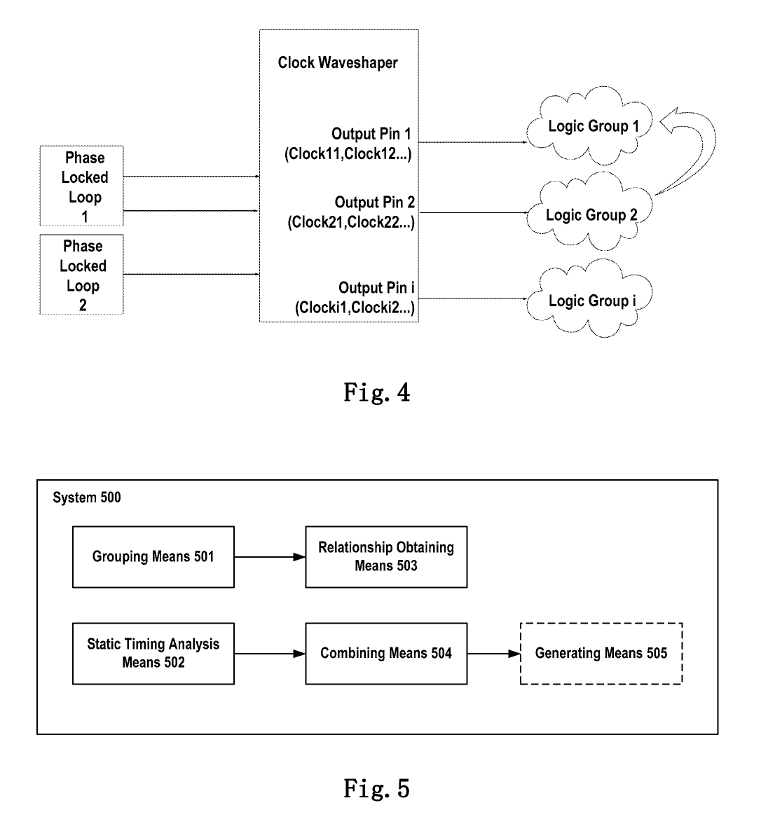

Hereinafter, the schematic circuit view of FIG. 4 is taken as an example to define a data structure describing relationships between logic groups in multiple timing modes, which data structure includes interactions, interaction directions and related parameters between the logic groups. This data structure can be described using Table 3 or other similar data structures, so long as relationships like array and chain table can be denoted.

TABLE 3
Data Table Structure Describing Relationships
Between Logic Groups in Multiple Timing Modes

| | | All clocks of | | | | |
|---|---|---|---|---|---|---|
| | Clock | clock physical | | | | |
| Logic group | physical | root of current | Logic | Logic | | Logic |
| index | root | logic group | group 1 | group 2 | . . . | group j |
| Logic | Output | Clock 11 | DTA | DTA | DTA | DTA |
| group 1 | pin 1 | Clock 12 | [timing | [timing | [timing | [timing |
| | | . . . | exceptions] | exceptions] | exceptions] | exceptions] |
| | | | Minimum | | | |
| | | | pulse width | | | |
| | | | of the clock | | | |
| Logic | Output | Clock 21 | DTA | DTA | DTA | DTA |
| group 2 | pin 2 | Clock 22 | [timing | [timing | [timing | [timing |
| | | . . . | exceptions] | exceptions] | exceptions] | exceptions] |
| | | | | Minimum | | |
| | | | | pulse width | | |
| | | | | of the clock | | |
| . . . | . . . | . . . | . . . | . . . | . . . | . . . |
| Logic | Output | Clock i1 | DTA | DTA | DTA | DTA |
| group i | pin i | Clock i2 | [timing | [timing | [timing | [timing |
| | | | exceptions] | exceptions] | exceptions] | exceptions] |
| | | | | | | Minimum |
| | | | | | | pulse width |
| | | | | | | of the clock |

FIG. 4 is a conventional, schematic circuit view. In this circuit, a phased locked loop outputs a clock that is outputted to different logic domains through a clock waveshaper (combined by a frequency divider, waveform aligner, a gated clock and other devices), thereby fulfilling a logic function. According to Table 3, the first column is the index of a logic group, wherein each line contains one logic group, such as logic group 1, logic group 2, . . . , logic group i; the second column is the clock physical root of a current logic group, such as the output pin of the clock waveshaper in FIG. 4; the third column is all clocks of the clock physical root of the current logic group, such as all clocks on the output pin of the clock waveshaper in FIG. 4; the fourth, fifth, . . . , i^{th} columns correspond to respective logic groups; the cross section between each logic group line and each logic group column represents interaction parameters between two logic groups. The output of the above static timing analysis is a circuit with timing information from which interaction parameters between two logic groups can be obtained, including DTA. That is, the output of the static timing analysis includes the DTA parameter between every two clock phases between every two logic groups, such as DTA1, DTA2, DTA3 . . . . When in Table 3 i is equal to j, it indicates that a logic group further includes the minimum pulse width parameter of the clock inside. In each timing mode, it is possible to obtain a table like Table 3 representing relationships between logic groups in this timing mode.

Preferably, the interactions between the logic groups can contain many other parameters, such a false path in timing exceptions, a setup time check in timing exceptions, a hold time check in timing exceptions, etc. These parameters are generally obtained from the circuit with timing information that is outputted from the above static timing analysis.

Returning to FIG. 3, in step S304, the obtained relationships between the logic groups in each of the multiple given timing modes are combined. During the combination, the multiple given timing modes can be combined into one timing mode, which best saves the time spent in subsequent timing analysis. Of course, those skilled in the art can appreciate that the multiple given timing modes can be combined into a plurality of timing modes; as long as the number of the combined timing modes is less than that of the given multiple timing modes, the time spent in subsequent timing analysis can be saved. And the approach used during the combination process remains the same. Hereinafter the combination into one timing mode is taken as an example to describe the approach. During the combination, entries in all timing mode tables [the logic group i, the logic group j] are obtained; that is, if there are m timing modes, there are m tables like Table 3. Then, DTAs of the corresponding entries in the m tables such as in Table 3 are compared to pick up the minimum DTA. For example, if i=1, j=0 and m=3, DTAs of the corresponding entries in the m tables are 10 ns, 20 ns and 30 ns, respectively; in this case, the minimum DTA of 10 ns is picked up. Next, the minimum pulse width parameters of the clock when i=j in the m tables like Table 3 are compared. For example, if i=j=1 and m=3, DTAs and the minimum pulse width parameters of the clock in the corresponding entries in the m tables like Table 3 are 10 ns and 4.5 ns, 10 ns and 5 ns, 20 ns and 10 ns, respectively; in this case, first the minimum DTA is picked up, and then the maximum minimum pulse width parameter of the clock is picked up from the minimum pulse parameters of the clock in timing modes corresponding to the minimum DTA, i.e., 10 ns and 5 ns. In summary, the steps for combination include: for any two logic groups, obtaining the minimum DTA according to DTAs between the two logic groups in each of the multiple timing modes; in a logic group, obtaining the maximum one of the minimum pulse width parameter of the clock according to the minimum pulse width parameters of the clock in timing modes corresponding to the obtained minimum DTA.

Preferably, other user-defined parameters of the corresponding entries in the m tables like Table 3 can be compared, such as the timing exceptions parameter, the user-defined maximum delay parameter, etc. For the user-defined maximum delay parameter, for example, the maximum delay of 5 ns from a circuit node 1 to a circuit node 2 is required in a mode 1, and the maximum delay of 2 ns from the circuit node 1 to the circuit node 2 is required in a mode 2, then 2 ns is required in the combined mode.

In this way, the m tables like Table 3 are combined into one table in the form of Table 3, thereby obtaining a result of combination, i.e., combined timing mode relationships.

Take FIG. 1 as an example below. By using the method illustrated in FIG. 3, first a logic group 1 and a logic group 2 are created; obtained relationships between the logic group 1 and the logic group 2 in different timing modes (the timing mode 1 and the timing mode 2) are presented in Table 4 and Table 5; finally, combination is implemented. Table 6 presents combined timing mode relationships.

TABLE 4
Relationships Between Logic Group 1 and
Logic Group 2 in FIG. 1 in Timing Mode 1

| | Clock | All clocks of clock | | |
|---|---|---|---|---|
| Logic group | physical | physical root of | Logic | Logic |
| index | root | current logic group | group 1 | group 2 |
| Logic | Inst1/A | Clock11 = 20 ns | DAT = 20 ns | DTA = 10 ns |
| group 1 | | | | |
| Logic | Inst2/A | Clock21 = 50 ns | DAT = 10 ns | DAT = 50 ns |
| group 2 | | | | |

Preferably, in step S305, a timing constraint file is generated from the result of the combination. That is, a timing constraint file is generated by the combined table like Table 3. Then, designers can further proceed with design steps such as clock tree planning, so as to complete the entire design. Take Table 4 as an example. First, pick up entries when i=j=1 (hereinafter, i represents a logic group line, and j represents a logic group column), i.e., DTA=20 ns and the minimum pulse width of the clock=10 ns, then it is transformed into the following timing constraint code:

TABLE 5
Relationships Between Logic Group 1 and
Logic Group 2 in FIG. 1 in Timing Mode 2

| | Clock | All clocks of clock | | |
|---|---|---|---|---|
| Logic group | physical | physical root of | Logic | Logic |
| index | root | current logic group | group 1 | group 2 |
| Logic | Inst1/A | Clock11 = 40 ns | DAT = 40 ns | DTA = 40 ns |
| group 1 | | | | |
| Logic | Inst2/A | Clock21 = 40 ns | DAT = 40 ns | DAT = 40 ns |
| group 2 | | | | |

TABLE 6
Relationships Between Logic Group 1 and Logic
Group 2 in FIG. 1 after Mode Combining

| | Clock | All clocks of clock | | |
|---|---|---|---|---|
| Logic group | physical | physical root of | Logic | Logic |
| index | root | current logic group | group 1 | group 2 |
| Logic | Inst1/A | Clock11 = 20 ns | Minimum | Minimum |
| group 1 | | | DAT = 20 ns | DTA = 10 ns |
| Logic | Inst2/A | Clock21 = 50 ns | Minimum | Minimum |
| group 2 | | Clock22 = 40 ns | DAT= 10 ns | DAT = 50 ns |

sdc::create_clock -name clk11 -period 20 ns -waveform [list 0.0 10ns]
inst1/A;
sdc::set_min_pulse_width -value 10 ns -object_list clk11

Next, pick up the entry that i=1 and j=2, i.e., DTA=10 ns, then it is transformed into the following timing constraint code:

sdc::create_clock -name clk11 -period 20 ns -waveform [list 0.0 10 ns]
inst1/A;
sdc::create_clock -name clk21 -period 50 ns -waveform [list 0.0 25ns]
inst2/A;
sdc::set min_pulse_width -value 10 ns -object_list clk11
sdc::set min_pulse_width -value 25 ns -object_list clk21

Next, pick up the entry that i=2 and j=1, i.e., DTA=10 ns, then it is transformed into the following timing constraint code:

sdc::create_clock -name clk11 -period 20 ns -waveform [list 0.0 10 ns]
inst1/A;
sdc::create_clock -name clk21 -period 50 ns -waveform [list 0.0 25 ns]
inst2/A;
sdc::set_min_pulse_width -value 10 ns -object_list clk11
sdc::set_min_pulse_width -value 25 ns -object_list clk21

Next, pick up the entry that i=2 and j=2, i.e., DTA=40 ns and the minimum pulse width of the clock=20 ns, then it is transformed into the following timing constraint code:

sdc::create_clock -name clk22 -period 40 ns -waveform [list 0.0 20ns]
inst2/A;
sdc::set_min_pulse_width -value 20 ns -object_list clk22

Finally, since clk22 is not used in any entry that i is no equal to j, add:

sdc::set_false_path -from clk11 -to clk22
sdc::set_false_path -to clk11 -from clk22

Then, consolidate the code, remove completely identical code, and obtain the generated timing constraint file. That is, generate the timing constraint file as below:

sdc::create_clock -name clk11 -period 20 ns -waveform [list 0.0 10ns]
inst1/A;
sdc::create_clock -name clk21 -period 50 ns -waveform [list 0.0 25ns]
inst2/A;
sdc::create_clock -name clk22 -period 40 ns -waveform [list 0.0 20ns]
inst2/A;
sdc::set_min_pulse_width -value 10 ns -object_list clk11
sdc::set_min_pulse_width -value 25 ns -object_list clk21
sdc::set_min_pulse_width -value 20 ns -object_list clk22
sdc::set_false_path -from clk11 -to clk22
sdc::set_false_path -to clk11 -from clk22

On the one hand, the present invention takes the structure of a circuit into consideration while dividing logic devices into logic groups.

On the other hand, regarding FIG. 2, the present invention can detect that the logic domain B is driven by a clock along the path 2 in the function timing mode and by a clock along the path 1 in the ASST timing mode, and the present invention will pick up different DTA parameters, namely DTA1 and DTA2 between these two clocks when A interacts with B. Hence, the minimum DTA can be obtained, written into the timing mode file and finally transformed into the timing constraint file. Therefore, it is ensured that the ASST mode is completely included in the timing mode under the finally combined timing constraint file, and in turn, it is possible to solve the problems in the combination of FIG. 1 and FIG. 2 by using the prior art. Moreover, the method of combining multiple timing modes makes it possible for designers to rapidly combine various kinds of clock modes and thereby reduce the design time and improve the design efficiency.

Regarding FIG. 2, if the method of the present invention is applied, then first the logic group 1 and the logic group 2 are created, obtained relationships between the logic group 1 and the logic group 2 in different timing modes are presented in Table 7 and Table 8, the different timing modes are finally combined, and the combined timing mode relationships are presented in Table 9.

TABLE 7
Relationships Between Logic Group 1 and
Logic Group 2 in FIG. 2 in Timing Mode 1

| | Clock | All clocks of clock | | |
|---|---|---|---|---|
| Logic group | physical | physical root of | Logic | Logic |
| index | root | current logic group | group 1 | group 2 |
| Logic | ICG/output | Clock11 = | DAT = | DTA = |
| group 1 | | 4 ns | 4 ns | NA |
| Logic | HSS/RXxD | Clock21 = | DAT = | DAT = |
| group 2 | CLK | 2 ns | NA | 2 ns |

TABLE 8
Relationships Between Logic Group 1 and
Logic Group 2 in FIG. 2 in Timing Mode 2

| | Clock | All clocks of clock | | |
|---|---|---|---|---|
| Logic group | physical | physical root of | Logic | Logic |
| index | root | current logic group | group 1 | group 2 |
| Logic | ICG/output | Clock11 = | DAT = | DTA = |
| group 1 | | 4 ns | 4 ns | 4 ns |
| Logic | HSS/RXxD | Clock21 = | DAT = | DAT = |
| group 2 | CLK | 0 ns | 4 ns | 4 ns |

TABLE 9
Relationships Between Logic Group 1 and Logic
Group 2 in FIG. 2 after Mode Combining

| | Clock | All clocks of clock | | |
|---|---|---|---|---|
| Logic group | physical | physical root of | Logic | Logic |
| index | root | current logic group | group 1 | group 2 |
| Logic | ICG/output | Clock11 = | Minimum | Minimum |
| group 1 | | 4 ns | DAT = | DTA = |
| | | | 4 ns | 4 ns |
| Logic | HSS/RXxD | Clock21 = | Minimum | Minimum |
| group 2 | CLK | 2 ns | DAT = | DAT = |
| | | Clock22 = | 4 ns | 2 ns |
| | | 4 ns | | |

The outputted timing constraint file is as below for FIG. 2, wherein the input is as shown in Table 9 while the output is the following timing constraint file:

sdc::create_clock -name clk11 -period 4 ns -waveform [list 0.0 2
ns]
ICG/output;sdc::create_clock -name clk21 -period 2 ns -waveform
[list 0.0 1 ns]

IHSS/RXxDCLK

sdc::create_clock -name clk11 -period 4 ns -waveform [list 0.0 2
ns]

IHSS/RXxDCLK

sdc::set_false_path -from clk11 -to clk21
sdc::set_false_path -to clk11 -from clk21

Under the same inventive concept, the present invention further discloses a system for combining multiple timing modes of an integrated circuit. FIG. 5 illustrates a structural block diagram of a system 500 for combining multiple timing modes of an integrated circuit. According to FIG. 5, the system includes: grouping means 501 configured to create a logic group for a logic device in the circuit according to a clock driving the logic device; static timing analysis means 502 configured to perform static timing analysis to the circuit in multiple given timing modes; relationship obtaining means 503 configured to obtain relationships between the logic groups in each of the multiple given timing modes according to a result of the static timing analysis; and combining means 504 configured to combine the obtained relationships between the logic groups in each of the multiple given timing modes. Preferably, the system further includes generating means 505 configured to generate a timing constraint file from a result of the combination.

In one embodiment, logic devices driven by the same clock are in the same one among the logic groups created by the grouping means.

In one embodiment, the relationships between the logic groups between each timing mode include: whether there exists an interaction between the logic groups, interaction directions, an interaction parameter, and a parameter of internal interaction of the logic group.

In another embodiment, it is possible to determine whether there exists an interaction between the logic groups and to an obtain interaction direction by one of: (1) propagating the clock in the circuit during the static timing analysis to determine whether there exists the interaction between the logic groups and to obtain the interaction direction, (2) forward or backward tracing respective logic devices in the logic group to determine whether there exists the interaction between the logic group and other logic groups and to obtain the interaction direction, and (3) traversing all connection relationships between all logic devices in the circuit to determine whether there exists the interaction between the logic groups and to obtain the interaction direction.

In the foregoing embodiment, interaction parameters between the logic groups are obtained by the circuit that contains timing information and that is outputted during the static timing analysis. The interaction parameters between the logic groups include DTA parameter, and parameters of internal interactions of the same logic group further include a minimum pulse width parameter of the clock.

In a further embodiment, the combining means is further configured to: for any two logic groups, obtain the minimum DTA parameter according to DTA parameters between the two logic groups in each of the multiple timing modes; in a logic group, obtain a maximum one of the minimum pulse width parameters of the clock according to the minimum pulse width parameters of the clock in timing modes corresponding to the obtained minimum DTA parameter.

The present invention can be implemented as hardware, software or combination of hardware components and software components. In a preferred embodiment, the present invention is implemented as software, including, without limitation to, firmware, resident software, micro-code, etc.

Moreover, the present invention can be implemented as a computer program product accessible by computer-usable or computer-readable media that provide program code for use by or in connection with a computer or any instruction executing system. For the purpose of description, a computer-usable or computer-readable medium can be any tangible means that can contain, store, communicate, propagate, or transport the program for use by or in connection with an instruction execution system, apparatus, or device.

The medium can be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CD-R/W), and DVD.

A data processing system adapted for storing and/or executing program code according to embodiment of the present invention would include at least one processor that is coupled to a memory element directly or via a system bus. The memory element can include a local memory usable during actually executing the program code, a mass memory, and a cache that provides temporary storage for at least one portion of program code so as to decrease the number of times for retrieving code from the mass memory during execution.

An Input/Output or I/O device (including, without limitation to, a keyboard, a display, a pointing device, etc.) can be coupled to the system directly or via an intermediate I/O controller.

A network adapter can also be coupled to the system such that the data processing system can be coupled to other data processing systems, remote printers or storage devices via an intermediate private or public network. A modem, a cable modem, and an Ethernet card are merely examples of a currently available network adapter.

It should be understood from the foregoing description that various modifications and alterations can be made to the embodiments of the present invention without departing from the real spirit of the present invention. The description presented in this specification is merely for the purpose of illustration and should not be construed as limiting. The scope of the present invention is only defined by the appended claims.

What is claimed is:

1. A method of combining multiple timing modes of an integrated circuit, the method comprising the steps of:
creating logic groups for at least one logic device in the circuit according to at least one clock driving the at least one logic device;
performing static timing analysis to the circuit in multiple given timing modes;
obtaining at least one relationship between the logic groups in each of the multiple given timing modes according to a result of the static timing analysis; and
combining the obtained at least one relationship between the logic groups in each of the multiple given timing modes.

2. The method according to claim 1, wherein logic devices driven by a same clock are in a same group among the logic groups created.

3. The method according to claim 2, wherein the at least one relationship between the logic groups in the each timing mode comprise: i) whether there exists an interaction between the logic groups, ii) an interaction direction associated with the logic groups, iii) an interaction parameter associated with the logic groups, and iv) a parameter of internal interaction associated with at least one of the logic groups.

4. The method according to claim 3, wherein to determine whether an interaction exists between the logic groups and to obtain an interaction direction is achieved by one of the following: i) propagating the at least one clock in the circuit during the static timing analysis to determine whether the interaction exists and to obtain the interaction direction, ii) forward tracing respective logic devices in at least one of the logic groups to determine whether the interaction exists and to obtain the interaction direction, iii) backward tracing respective logic devices in at least one of the logic groups to determine whether the interaction exists and to obtain the interaction direction, iv) traversing all connection relationships between all logic devices in the circuit to determine whether the interaction exists and to obtain the interaction direction.

5. The method according to claim 3, wherein the interaction parameter associated with the logic groups is obtained by a circuit that contains timing information and that is outputted during the static timing analysis.

6. The method according to of claims 3, wherein the interaction parameter associated with the logic groups comprises a delay and timing adjustment DTA parameter, and the parameter of internal interaction of the at least one logic group further comprises a minimum pulse width parameter of the clock.

7. The method according to claim 6, wherein the combining step further comprises the steps of:
for any two logic groups, obtaining a minimum DTA parameter according to DTA parameters between the two logic groups in each of the multiple timing modes; and
in the at least one logic group associated with the parameter of internal interaction, obtaining a maximum one of minimum pulse width parameters of the clock according to minimum pulse width parameters of the clock in timing modes corresponding to the obtained minimum DTA parameter.

8. The method according to claim 1, further comprising the step of: generating a timing constraint file from a result of the combination.

9. A system for combining multiple timing modes of an integrated circuit, the system comprising:
grouping means configured to create logic groups for at least one logic device in the circuit according to at least one clock driving the at least one logic device;
static timing analysis means configured to perform static timing analysis to the circuit in multiple given timing modes;
relationship obtaining means configured to obtain at least one relationship between the logic groups in each of the multiple given timing modes according to a result of the static timing analysis; and
combining means configured to combine the obtained at least one relationship between the logic groups in each of the multiple given timing modes.

10. The system according to claim 9, wherein logic devices driven by a same clock are in a same logic group of the logic groups created.

11. The system according to claim 10, wherein the at least one relationship between the logic groups in the each timing mode comprise: i) whether there exists an interaction between the logic groups, ii) an interaction direction associated with the logic groups, iii) an interaction parameter associated with the logic groups, and iv) a parameter of internal interaction associated with at least one of the logic groups.

12. The system according to claim 11, wherein the interaction parameter associated with the logic groups is obtained by a circuit that contains timing information and that is outputted during the static timing analysis.

13. The system according to any of claim 11, wherein the interaction parameter associated with the logic groups comprises a delay and timing adjustment DTA parameter, and the parameter of internal interaction of the at least one logic group further comprises a minimum pulse width parameter of the clock.

14. The system according to claim 15, wherein the combining means is further configured to:
for any two logic groups, obtaining a minimum DTA parameter according to DTA parameters between the two logic groups in each of the multiple timing modes; and
in the at least one logic group associated with the parameter of internal interaction, obtaining a maximum one of minimum pulse width parameters of the clock according to minimum pulse width parameters of the clock in timing modes corresponding to the obtained minimum DTA parameter.

15. The system according to claim 9, further comprising generating means configured to generate a timing constraint file from a result of the combination.
